(19) United States
(12) Patent Application Publication
(10) Pub. No.: US 2008/0058496 A1
(43) Pub. Date: Mar. 6, 2008

(54) Polyamic acid-based composition, and liquid crystal orienting agent and orienting film containing the same

(75) Inventors: Ya-Pin Chen, Chiayi Hsien (TW); Chuan-Ter Yan, Kaohsiung City (TW); Chih-Hsiung Huang, Kaohsiung City (TW); Chao-Ching Huang, Kaohsiung City (TW); Chin-Wang Kao, Kaohsiung Hsien (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: DAILY POLYMER CO., LTD.

(21) Appl. No.: 11/511,214

(22) Filed: Aug. 29, 2006

(51) Int. Cl. C08G 69/08

(52) U.S. Cl. 528/310

(57) ABSTRACT

A polyamic acid-based composition is prepared by reacting a diamine reactant and a dianhydride reactant. The diamine reactant includes 20-70 mol % of a fluorine-containing diamine component having a trifluoromethyl group substituted main chain, and 30-80 mol % of a fluorine-free diamine component. The dianhydride reactant includes 65-100 mol % of an aromatic tetracarboxylic dianhydride component and 0-35 mol % of an aliphatic tetracarboxylic dianhydride component. A liquid crystal orienting agent includes the aforesaid polyamic acid-based composition and a solvent. A liquid crystal orienting film is formed by a process including: preparing a mixture containing the aforesaid polyamic acid-based composition and a solvent; coating the mixture onto a substrate so as to form a film on the substrate; and heating the film so as to convert polyamic acid of the polyamic acid-based composition into polyamide.

### BACKGROUND OF THE INVENTION

1. Field of the Invention

This invention relates to a polyamic acid-based composition, a liquid crystal orienting agent, and a liquid crystal orienting film formed from the polyamic acid-based composition.

2. Description of the Related Art

Because of lightweight and low power consumption characteristics of a liquid crystal display apparatus, a miniature portable personal information device with a liquid crystal display panel has been widely developed. The arrangement of liquid crystal molecules in a liquid crystal layer of the liquid crystal display apparatus can be changed using an external electric field, thereby adjusting the transmitted amount of incident light. Based on different arrangements of the liquid crystal molecules, liquid crystal display apparatus presently in practical use can be classified into a twisted nematic (TN) liquid crystal display apparatus twisted by 90°, a super twisted nematic (STN) liquid crystal display apparatus twisted by 180° or more, or a liquid crystal display apparatus utilizing thin film transistors (TFT).

Since a miniature device normally cannot be used under a high driving voltage, a liquid crystal display apparatus requiring lower driving voltage and having improved properties has been demanded. The properties required to be improved include the pre-tilt angle, electrical properties such as current consumption, voltage holding ratio, and residual voltage, and the reliability of the aforesaid properties in long-term use.

In general, the required pre-tilt angle for liquid crystals is changed based on the driving system of the liquid crystal display apparatus. For example, TN type requires a pre-tilt angle of 1 to 6°, and STN type requires a pre-tilt angle of 3 to 8°. In TFT liquid crystal display apparatus, high voltage holding ratio (99%) is required, but requirement for liquid crystal orientation is low. However, in STN liquid crystal display apparatus, 80% voltage holding ratio is sufficient, but requirement for liquid crystal orientation is high. That is, undesired domains that adversely affect the orienting property of the liquid crystal material should be minimized in STN liquid crystal display apparatus.

Furthermore, in consideration of the effective reduction of current consumption, a liquid crystal with good voltage holding ratio and low current consumption is widely employed, such as liquid crystal material containing cyano group (—CN) and/or fluorine-containing group (—F, —CF₃). However, the liquid crystal material containing cyano group is likely to absorb water so as to increase current consumption and decrease voltage holding ratio, thereby resulting in a reduction in reliability of electrical properties of the display apparatus. To overcome the problem, a fluorine group-containing liquid crystal material is employed. However, when the fluorine group-containing liquid crystal material is used, many undesired domains occur, especially at an interface between peripheral seal and liquid crystal so as to adversely affect the orienting property of the liquid crystal material.

To meet the aforesaid demands, research has focused on the modification of constituents of a liquid crystal orienting film. For example, Chisso Corporation of Japan has proposed polyamic acid-based compositions disclosed in, for example, U.S. Pat. No. 6,620,339 and U.S. Pat. No. 6,946,169 B1. U.S. Pat. No. 6,946,169 B1 discloses a polyamic acid-based composition comprising a polyamic acid A with an excellent electrical property and a polyamic acid B including a diamine with side chains. The polyamic acid A includes an acid component and an amine component. The acid component includes aliphatic tetracarboxylic dianhydride and/or alicyclic tetracarboxylic dianhydride. The amine component is an aromatic diamine represented by the following formula (1):

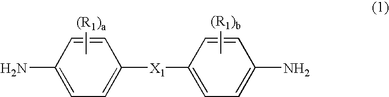

wherein X₁ is a divalent aliphatic group, each R₁ is independently H or CH₃, and a and b are 1 to 2.

The polyamic acid B includes an acid component and an amine component. The acid component contains 50 mol % or more aromatic tetracarboxylic dianhydride. The amine component is a diamine having a group enabling the pre-tilt angle of a liquid crystal to be increased on the side chain thereof. The diamine component contains the following compound of formula (2):

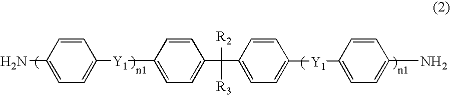

wherein Y₁ is a CH₂ group or an oxygen atom, each of R₂ and R₃ is independently a hydrogen atom or an alkyl group or a perfluoroalkyl group having 1 to 12 carbon atoms, and n1 is 0 or 1. At least one of the R₂ and R₃ should be an alkyl group having three or more carbon atoms for increasing the pre-tilt angle of a liquid crystal. The weight ratio of the polyamic acid A to the polyamic acid B is 50/50 to 95/5.

Although the patent provides a liquid crystal orienting film for obtaining a liquid crystal display having an optimal pre-tilt angle and low current consumption, the problem of undesired domains that occur at the interface between the seal and the liquid crystal is not addressed in this patent.

### SUMMARY OF THE INVENTION

Therefore, the object of the present invention is to provide a polyamic acid-based composition, a liquid crystal orienting agent, and a liquid crystal orienting film obtained from the polyamic acid-based composition, that can overcome the undesired domain problem associated with the prior art.

According to one aspect of this invention, a polyamic acid-based composition is prepared by a process comprising reacting a diamine reactant and a dianhydride reactant. The diamine reactant includes 20-70 mol % of a fluorine-containing diamine component having a trifluoromethyl group substituted main chain, and 30-80 mol % of a fluorine-free diamine component. The dianhydride reactant includes 65-100 mol % of an aromatic tetracarboxylic dianhydride component and 0-35 mol % of an aliphatic tetracarboxylic dianhydride component.

According to another aspect of this invention, a liquid crystal orienting agent comprises the aforesaid polyamic acid-based composition and a solvent.

According to yet another aspect of this invention, a liquid crystal orienting film is formed by a process comprising: preparing a mixture containing the aforesaid polyamic acid-based composition and a solvent; coating the mixture onto a substrate so as to form a film on the substrate; and heating the film so as to convert polyamic acid of the polyamic acid-based composition into polyamide.

### BRIEF DESCRIPTION OF THE DRAWINGS

Other features and advantages of the present invention will become apparent in the following detailed description of the preferred embodiments of this invention, with reference to the accompanying drawings, in which:

FIGS. 1 to 10 are polarizing microscope photographs showing the results of occurrence of undesired domains in tested samples formed by the first to tenth preferred embodiments of liquid crystal orienting films according to this invention; and

FIGS. 11 to 18 are polarizing microscope photographs showing the results of occurrence of undesired domains in comparative tested samples formed by liquid crystal orienting films of the first to eighth comparative examples.

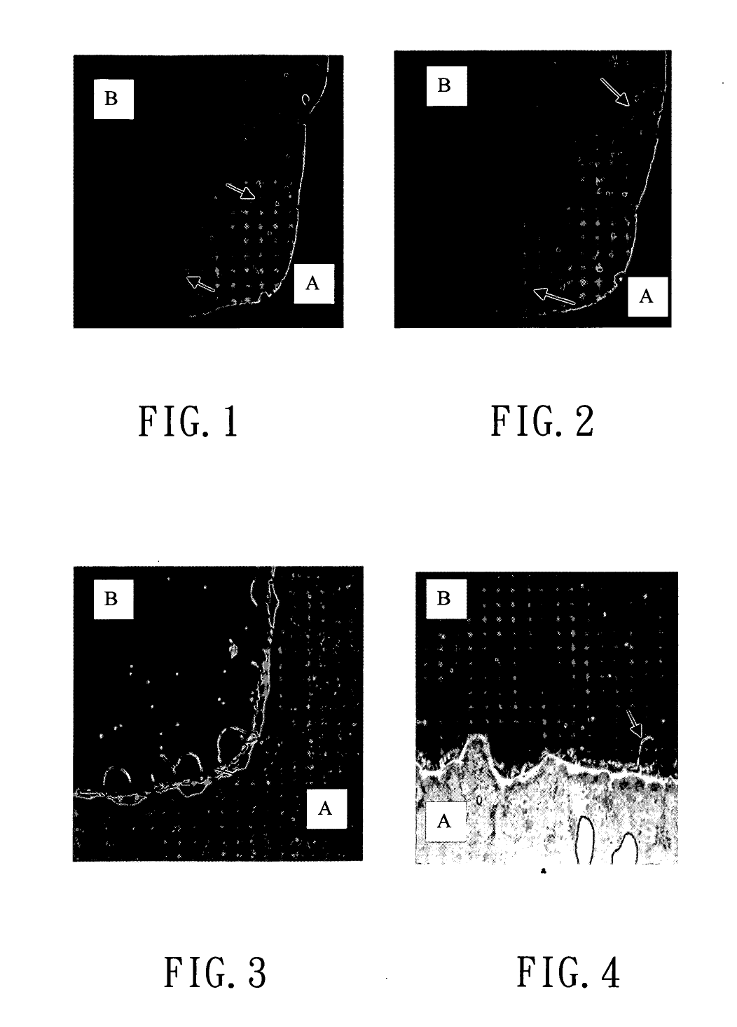

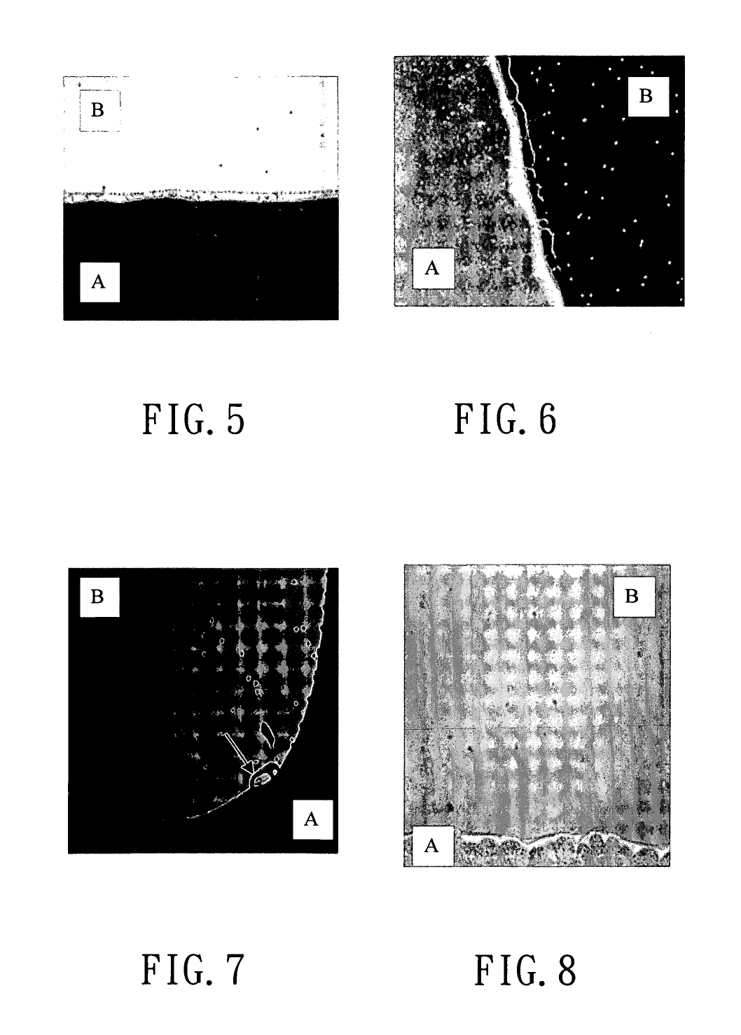

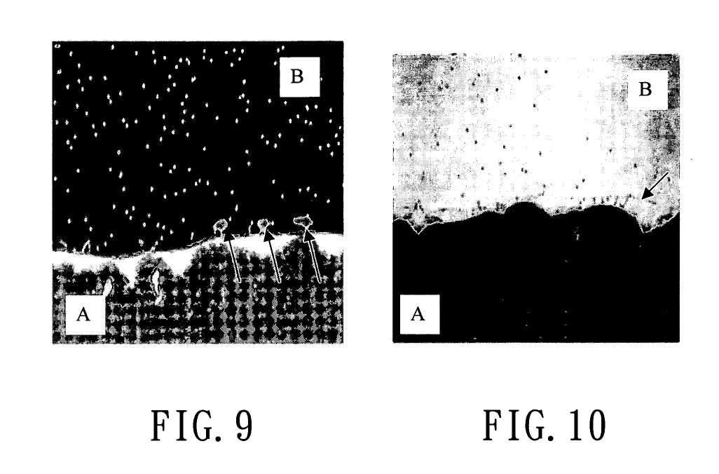

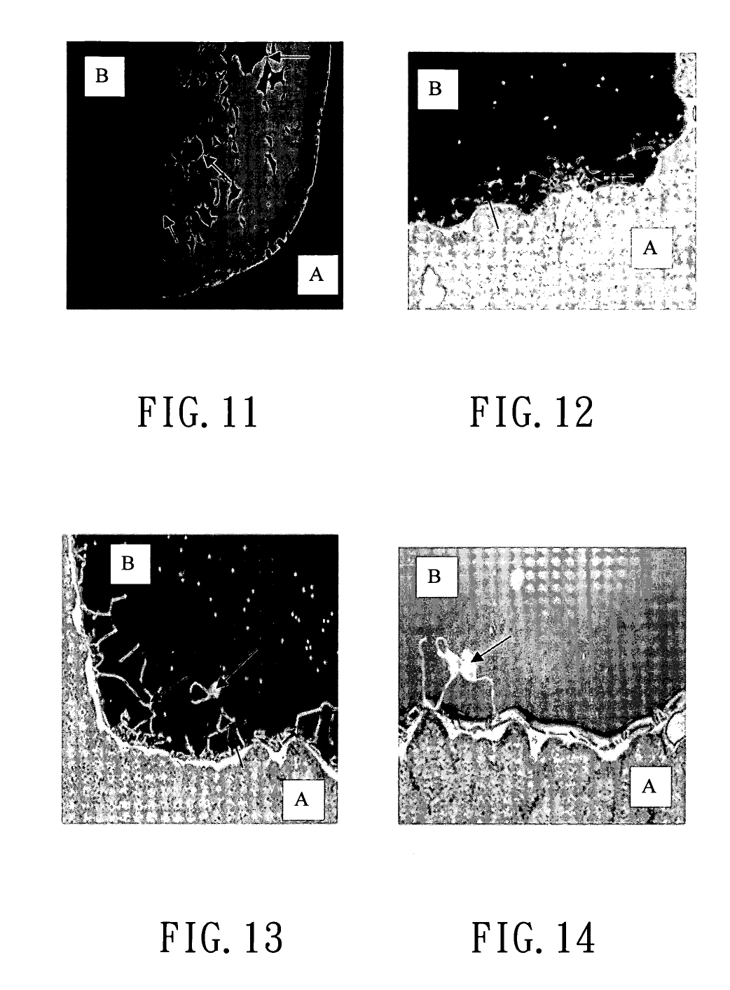

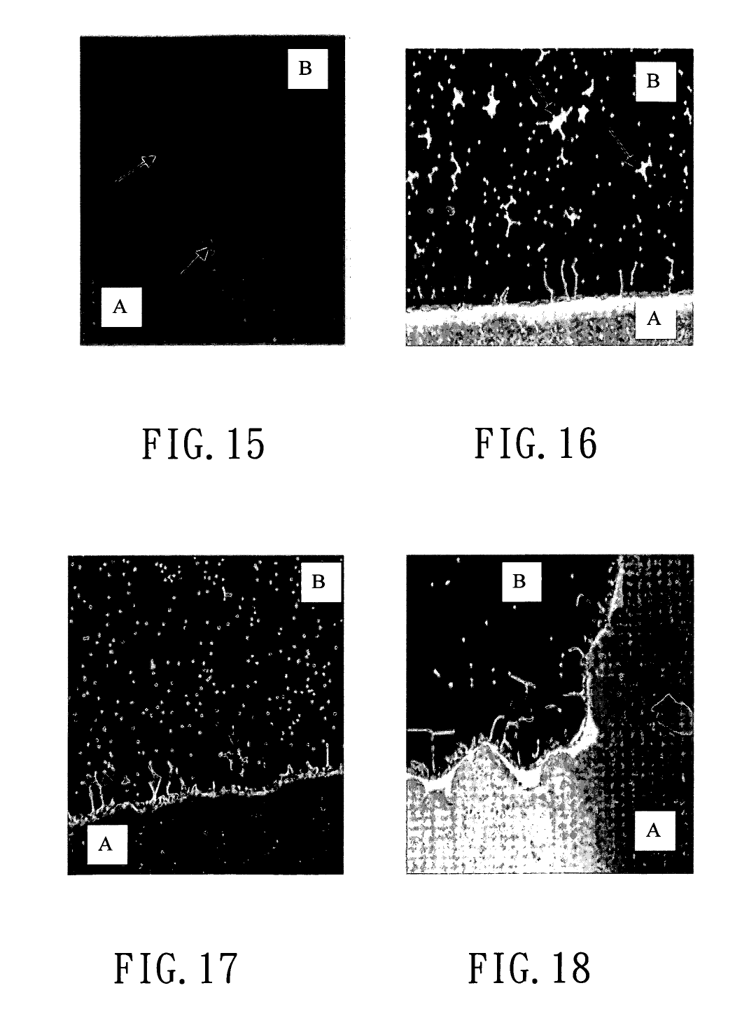

### DETAILED DESCRIPTION OF THE PREFERRED EMBODIMENTS

A polyamic acid-based composition according to this invention is prepared by reacting a diamine reactant and a dianhydride reactant. The diamine reactant includes 20-70 mol % of a fluorine-containing diamine component having a trifluoromethyl group substituted main chain and 30-80 mol % of a fluorine-free diamine component. The dianhydride reactant includes 65-100 mol % of an aromatic tetracarboxylic dianhydride component and 0-35 mol % of an aliphatic tetracarboxylic dianhydride component.

Preferably, the main chain of the fluorine-containing diamine component is substituted by at least two trifluoromethyl groups.

In the polyamic acid-based composition of this invention, if the fluorine-containing diamine component is greater than 70 mol % or less than 20 mol %, the amount of the undesired domains are likely to increase so that orienting property of the liquid crystal is decreased. Preferably, the fluorine-containing diamine component is present in an amount ranging from 20 to 50 mol %, and the fluorine-free diamine component is present in an amount ranging from 50 to 80 mol %. More preferably, the fluorine-containing diamine component is present in an amount ranging from 20 to 35 mol %, and the fluorine-free diamine component is present in an amount ranging from 65 to 80 mol %.

Similarly, if the aromatic tetracarboxylic dianhydride component is less than 65 mol %, many undesired domains are likely to occur, thereby resulting in a decrease in the orienting property of the liquid crystal. Preferably, the aromatic tetracarboxylic dianhydride component is present in an amount ranging from 65 to 90 mol %, and the aliphatic tetracarboxylic dianhydride component is present in an amount ranging from 10 to 35 mol %. More preferably, the aromatic tetracarboxylic dianhydride component is present in an amount ranging from 65 to 80 mol %, and the aliphatic tetracarboxylic dianhydride component is present in an amount ranging from 20 to 35 mol %.

The molar ratio of the diamine reactant to the dianhydride reactant ranges from 1:0.9 to 1:1.

Preferably, the fluorine-containing diamine component is selected from the group consisting of 2,2-bis[4-(4-aminophenoxy)phenyl]hexafluoropropane (HFBAPP), 2,2-bis(4-aminophenoxy)hexafluoropropane, 2,2′-bis[4-(4-amino-2-trifluoromethylphenoxy)phenyl]hexafluoropropane, 4,4′-diamino-2,2′-bis(trifluoromethyl)biphenyl, 4,4′-bis[(4-amino-2-trifluoromethyl)phenoxy]octafluorobiphenyl, and mixtures thereof. In one example of this invention, the fluorine-containing diamine component is 2,2-bis[4-(4-aminophenoxy)phenyl]hexafluoropropane (HFBAPP).

The fluorine-free diamine component can be a fluorine-free aromatic diamine or a fluorine-free aliphatic diamine. Preferably, the fluorine-free diamine component is a fluorine-free aromatic diamine, and is selected from the group consisting of 4,4′-bis(4-aminophenoxy)biphenyl (BAPB), p-phenylenediamine, m-phenylenediamine, 4,4′-diamino-3,3′-dicarboxydiphenylmethane, 1,4-bis(4-aminophenyl)benzene, 4,4′-diaminobiphenyl, 3,3′-dimethyl-4,4′-diaminobiphenyl, 3,3′-dimethoxy-4,4′-diaminobiphenyl, 3,3′-dihydroxy-4,4′-diaminobiphenyl, 3,3′-dichloro-4,4′-diaminobiphenyl, 3,3′-dicarboxy-4,4′-diaminobiphenyl, diaminodiphenylmethane, diaminodiphenyl ether, 2,2-diaminodiphenylpropane, 4,4′-diaminodiphenylsulfone, diaminobenzophenone, 1,3-bis(4-aminophenoxy)benzene, 1,4-bis(4-aminophenoxy)benzene, 4,4′-di(4-aminophenoxy)diphenylsulfone, 2,2-bis-[4-(4-aminophenoxy)phenyl]propane, a compound of formula (II), and mixtures thereof. In one example of this invention, the fluorine-free diamine component is a mixture of 4,4′-bis(4-aminophenoxy)biphenyl (BAPB) and the compound of formula (II) at a molar ratio ranging from 2:1 to 26:1.

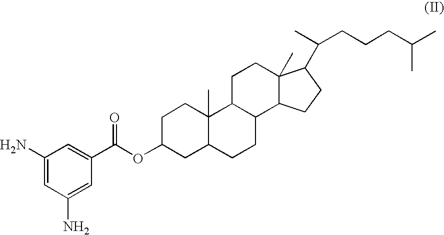

The aromatic tetracarboxylic dianhydride component is selected from the group consisting of pyromellitic dianhydride (PMDA), biphenyl tetracarboxylic dianhydride (BPDA), 1,4,5,8-naphthalenetetracarboxylicdianhydride, 2,3,6,7-naphthalenetetracarboxylic dianhydride, 3,3′,4,4′-dimethyldiphenylsilanetetracarboxylic dianhydride, 3,3′,4,4′-tetraphenylsilanetetracarboxylic dianhydride, 1,2,3,4-furanetetracarboxylic dianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, bis(phthalic acid)phenylphosphine oxide dianhydride, p-phenylene-bis(triphenylphthalic)dianhydride, m-phenylene-bis(triphenylphthalic)dianhydride, bis(triphenylphthalic acid)-4-4′-diphenylether dianhydride, bis(triphenylphthalic acid)-4-4′-diphenylmethane dianhydride, and mixtures thereof. In one example of this invention, the aromatic tetracarboxylic dianhydride component is a mixture of pyromellitic dianhydride (PMDA) and biphenyl tetracarboxylic dianhydride (BPDA) at a molar ratio ranging from 1:1 to 9:1.

The aliphatic tetracarboxylic dianhydride component is selected from the group consisting of bicycle(2,2,2)oct-7-ene-2,3,5,6-tetracarboxylic dianhydride (BCDA), 1,2,3,4-butanetetracarboxylic dianhydride (BDA), 3,4-dicarboxy-1,2,3,4-tetrahydro-1-naphthalene succinicanhydride (TDA), 2,3,5-tricarboxycyclopentylacetic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 3,5,6-tricarboxynorbornane-2-acetic dianhydride, 2,3,4,5-tetrahydrofurantetracarboxylic dianhydride, and mixtures thereof. In one example of this invention, the aliphatic tetracarboxylic dianhydride component is selected from the group consisting of bicycle(2,2,2)oct-7-ene-2,3,5,6-tetracarboxylic dianhydride (BCDA), 1,2,3,4-butanetetracarboxylic dianhydride (BDA), and 3,4-dicarboxy-1,2,3,4-tetrahydro-1-naphthalene succinicanhydride (TDA).

The reaction conditions (e.g., temperature, pressure, time, etc.) of this invention vary based on properties of the reactants.

A liquid crystal orienting agent is prepared by dissolving the polyamic acid-based composition of this invention in a solvent at room temperature. The amounts of the polyamic acid-based composition and the solvent vary based on actual requirements. Preferably, based on the total weight of the liquid crystal orienting agent, the solvent is present in an amount ranging from 80 to 96 wt %, more preferably, from 92 to 96 wt %. The solvent used in this invention is selected from the group consisting of N-methyl-2-pyrrolidinone (NMP), ethylene glycol monobutyl ether (BC), dimethylacetamide (DMAc), dimethylformamide (DMF), dimethylsulfoxide (DMSO), γ-butyrolactone, tetramethylurea, hexamethylphosphor triamide, m-cresol, xylenol, phenol, halogenated phenol chlorobenzene, dichloroethane, tetrachloroethane, cyclohexanone, and mixtures thereof. Preferably, the solvent is a mixture of N-methyl-2-pyrrolidinone (NMP) and ethylene glycol monobutyl ether (BC) at a weight ratio ranging from 90:10 to 60:40.

A liquid crystal orienting film of this invention is obtained by coating the aforesaid liquid crystal orienting agent onto a substrate so as to form a film on the substrate, and heating the film. During heating, the polyamic acid-based composition contained in the liquid crystal orienting agent undergoes dehydration and ring-closing process, which results in conversion of polyamic acid into polyamide so that the liquid crystal orienting film of polyamide is formed on the substrate. The liquid crystal orienting film thus formed can be used with a commercially available liquid crystal material (especially a fluorine group-containing liquid crystal material) so as to improve the orienting property of the liquid crystal material.

### EXAMPLES

The polyamic acid-based compositions of Examples 1 to 10 were prepared by mixing reactants (the specific species and amounts thereof are set forth in Table 1) with 500 g NMP so as to obtain a mixture, and stirring the mixture at 20° C. for 24 hours. The reaction was completed when the viscosity of the mixture as determined using a viscometer (LVDV-II+, available from Brookfield Company, USA) was not increased.

The method for preparing the polyamic acid-based compositions of comparative examples 1 to 8 was similar to that for preparing the polyamic acid-based composition of Examples 1 to 10 except that, in comparative examples 1 to 8, the fluorine-containing diamine component was not added and/or the amount of the aromatic tetracarboxylic dianhydride was less than 65% (see Table 1).

The reactant of formula (II) was prepared by: dissolving 3,5-dinitrobenzoyl chloride and cholesterol at a molar ratio of 1:1 in toluene so as to form a solution; adding 1 mole pyridine in the solution so as to form a mixture; reacting the mixture at 25° C. for 10 hours so as to obtain a product; purifying the product to obtain a dinitro-compound; and reducing the dinitro-compound so as to obtain the compound of formula (II).

TABLE 1

| | Amount of each of the reactants | | | | | | | |
|---|---|---|---|---|---|---|---|---|
| | | | Fluorine- | Aromatic | | Aliphatic | | |
| | Fluorine-free | | containing | tetracarboxylic | | tetracarboxylic | | |
| | diamine | | diamine | dianhydride | | dianhydride | | |
| Example No. | compound (II) | BAPB | HFBAPP | BPDA | PMDA | BCDA | BDA | TDA |
| Example 1 | 6 | 74 | 20 | 24 | 51 | 25 | — | — |
| Example 2 | 4 | 76 | 20 | 28 | 52 | — | 20 | — |
| Example 3 | 4 | 76 | 20 | 27 | 53 | — | 20 | — |
| Example 4 | 7 | 63 | 30 | 17 | 48 | — | 35 | — |
| Example 5 | 8 | 62 | 30 | 26 | 54 | — | 20 | — |
| Example 6 | 4 | 66 | 30 | 10 | 70 | — | 20 | — |
| Example 7 | 6 | 66 | 30 | 10 | 80 | — | 10 | — |
| Example 8 | 6 | 64 | 30 | 30 | 70 | — | — | — |
| Example 9 | 4 | 66 | 30 | 10 | 90 | — | — | — |
| Example 10 | 4 | 30 | 66 | 10 | 80 | — | 10 | — |
| comparative | 6 | — | 31 | 31 | — | — | — | 69 |
| Example 1 | | | | | | | | |
| comparative | 3 | — | 50 | 50 | — | — | 50 | — |
| Example 2 | | | | | | | | |
| Comparative | 7 | — | 100 | 100 | — | — | — | — |
| Example 3 | | | | | | | | |
| Comparative | 7 | 30 | 18 | 18 | 43 | — | 39 | — |
| Example 4 | | | | | | | | |
| Comparative | 6 | 30 | 30 | 30 | — | — | — | 70 |
| Example 5 | | | | | | | | |
| Comparative | 8 | 35 | 18 | 18 | 32 | — | 50 | — |
| Example 6 | | | | | | | | |
| Comparative | 4 | 66 | 10 | 10 | 24 | — | −66 | — |
| Example 7 | | | | | | | | |
| Comparative | 4 | 66 | 10 | 10 | 40 | — | −50 | — |
| Example 8 | | | | | | | | |

“—” means not added.

The polyamic acid-based composition of each of the examples was dissolved in a solvent containing NMP and BC at a weight ratio of 60:40 so as to obtain a liquid crystal orienting agent having about 6 wt % solid content. The viscosity of each of the orienting agents was determined using a viscometer (LVDV-II+, available from Brookfield Company, USA) at 23° C. The results thus obtained are shown in Table 2.

A liquid crystal orienting film was obtained by coating 3 g of each of the liquid crystal orienting agents on a 50 mm×50 mm substrate of indium tin oxide (ITO) using a spin coater at a speed of 4000 rpm/20 sec, preheating the substrate and the orienting agent at 80° C. for 10 minutes, and curing the orienting agent at 250° C. for 60 minutes to convert polyamic acid of the polyamic acid-based composition into polyamide so as to form the liquid crystal orienting film on the substrate.

### Test for Pre-Tilt Angle

Two ITO substrates independently coated with the same liquid crystal orienting film thus formed were subjected to a rubbing process using a rubbing machine (ESR-1, available from E-SUN Precision Industrial Co., Ltd., pile impression: 0.5 mm, rubbing roller diameter: 170 mm (700 rpm), stage speed 100 mm/min, and the rubbing cloth used was YA-18). One of the ITO substrates coated with the liquid crystal orienting film, a first polyethylene terephthalate film (having a size of 50 mm in length, 5 mm in width, and 50 μm in thickness), a second polyethylene terephthalate film, and the other ITO substrate coated with the same liquid crystal orienting film were stacked from top to bottom in this sequence so as to form a laminate having a periphery. The two liquid crystal orienting films on the ITO substrates of the laminate faced the first and second polyethylene terephthalate films, respectively. Then, a liquid crystal (DN-13231, available from Daily Polymer Corp., phase transition temperature thereof is 90° C., and a dopant was not added) was filled into a space between the first and second polyethylene terephthalate films. The laminate filled with the liquid crystal was applied with an adhesive (an epoxy resin AB glue available from Nan-Ya Plastics Co. was used in these examples) on the periphery thereof, followed by heating at 90° C. for 5 minutes so as to obtain samples to be tested. The pre-tilt angle of each of the samples was determined using a tilt bias angle measuring system (TBA 107™, available from Autronic Co., Germany). The results are shown in Table 2. It should be noted that the pre-tilt angle suitable for this invention ranges from 4 to 8°.

### Observation of Orienting Property

Two ITO substrates independently coated with the same liquid crystal orienting film were subjected to a rubbing process as described above. One of the ITO substrates was coated with a seal (available from Mitsui Chemicals, Inc., Japan) on a periphery of the liquid crystal orienting film such that a 20 μm gap was formed. A plurality of spacers (available from Mitsui Chemicals, Inc., Japan, 6.75 μm diameter) were disposed on the other of the ITO substrates at a density of 150-200/cm² so that, upon laminating, the two ITO substrates were spaced apart from each other by the spacers so as to form a space therebetween. Then, the two ITO substrates were laminated together in such a manner that the two liquid crystal orienting films respectively formed on the ITO substrates faced each other and were spaced apart from each other by the spacers. A liquid crystal (RD-16000-000, available from Daily Polymer Corp.) was filled into the space through the gap, followed by sealing the gap using an adhesive and curing the adhesive using ultraviolet light so as to obtain an element. The element was heated at 90° C. for 5 minutes so as to obtain a sample to be tested.

Undesired domains in each of the samples were observed using a polarizing microscope (Type 120, available from Nikon Company). As shown in the figures, “A” represents the seal, “B” represents the liquid crystal, circular dots in the liquid crystal represent the spacers, and lines and irregular areas indicated by arrows represent undesired domains.

It is noted from Table 2 that the pre-tilt angle in each of Examples 1 to 10 falls within the desired range (i.e., from 4 to 8°) so that the liquid crystal orienting films according to this invention meet industry requirements. The pre-tilt angle of the liquid crystal orienting film in Comparative Example 5 cannot be detected because of the existence of many undesired domains. Moreover, compared to the comparative examples 1 to 8 in which many undesired domains occur, in the examples of this invention, undesired domains do not occur (in Examples 5 and 8) or very few of them exist so that the orienting property of the liquid crystal can be improved.

TABLE 2

| | Viscosity of the | | Occurrence |
|---|---|---|---|
| | liquid crystal | | of the |
| | orienting agent | Pre-tilt | undesired |
| Example No. | (cp) | angle (°) | domains |
| Example 1 | 53 | 4.8 | Yes (few) |
| Example 2 | 50 | 5.1 | Yes (few) |
| Example 3 | 58 | 4.2 | Yes (few) |
| Example 4 | 53 | 6.7 | Yes (very few) |
| Example 5 | 46 | 7.4 | No |
| Example 6 | 56 | 4.4 | Yes (few) |
| Example 7 | 79 | 4.5 | Yes (few) |
| Example 8 | 150 | 4.7 | No |
| Example 9 | 52 | 4.3 | Yes (few) |
| Example 10 | 55 | 5.7 | Yes (very few) |
| Comparative | 38 | 8.3 | Yes (many) |
| Example 1 | | | |
| Comparative | 71 | 3.8 | Yes (many) |
| Example 2 | | | |
| Comparative | 148 | 4.4 | Yes (many) |
| Example 3 | | | |
| Comparative | 40 | 7.6 | Yes (many) |
| Example 4 | | | |
| Comparative | 21 | — | Yes (many) |
| Example 5 | | | |
| Comparative | 43 | 7.9 | Yes (many) |
| Example 6 | | | |
| Comparative | 47 | 5.1 | Yes (many) |
| Example 7 | | | |
| Comparative | 69 | 4.8 | Yes (many) |
| Example 8 | | | |

“—” means not detected.

With the inclusion of 20-70 mol % of a fluorine-containing diamine component having a trifluoromethyl group substituted main chain, 30-80 mol % of a fluorine-free diamine component, 65-100 mol % of an aromatic tetracarboxylic dianhydride component and 0-35 mol % of an aliphatic tetracarboxylic dianhydride component, the polyamic acid-based composition can not only provide a desired pre-tilt angle but also improve orienting property for the liquid crystal by decreasing the amount of undesired domains.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

1. A polyamic acid-based composition prepared by a process comprising reacting a diamine reactant and a dianhydride reactant, said diamine reactant including 20-35 mol % of a fluorine-containing diamine component having a trifluoromethyl group substituted main chain, and 65-80 mol % of a fluorine-free diamine component, said dianhydride reactant including 65-100 mol % of an aromatic tetracarboxylic dianhydride component and 0-35 mol % of an aliphatic tetracarboxylic dianhydride component.

2. The polyamic acid-based composition of claim 1, wherein said main chain is substituted by at least two trifluoromethyl groups.

3-4. (canceled)

5. The polyamic acid-based composition of claim 1, wherein said aromatic tetracarboxylic dianhydride component is present in an amount ranging from 65 to 90 mol %, and said aliphatic tetracarboxylic dianhydride component is present in an amount ranging from 10 to 35 mol %.

6. The polyamic acid-based composition of claim 5, wherein said aromatic tetracarboxylic dianhydride component is present in an amount ranging from 65 to 80 mol %, and said aliphatic tetracarboxylic dianhydride component is present in an amount ranging from 20 to 35 mol %.

7. The polyamic acid-based composition of claim 1, wherein the molar ratio of said diamine reactant to said dianhydride reactant ranges from 1:0.9 to 1:1.

8. The polyamic acid-based composition of claim 1, wherein said fluorine-containing diamine component is selected from the group consisting of 2,2-bis[4-(4-aminophenoxy)phenyl]hexafluoropropane, 2,2-bis(4-aminophenoxy)hexafluoropropane, 2,2′-bis[4-(4-amino-2-trifluoromethylphenoxy)phenyl) hexafluoropropane, 4,4′-diamino-2,2′-bis(trifluoromethyl)biphenyl, 4,4′-bis[(4-amino-2-trifluoromethyl)phenoxy]octafluorobiphenyl, and mixtures thereof.

9. The polyamic acid-based composition of claim 8, wherein said fluorine-containing diamine component is 2,2-bis[4-(4-aminophenoxy)phenyl]hexafluoropropane.

10. The polyamic acid-based composition of claim 1, wherein said aromatic tetracarboxylic dianhydride component is selected from the group consisting of pyromellitic dianhydride, biphenyl tetracarboxylic dianhydride, 1,4,5,8-naphthalenetetracarboxylic dianhydride, 2,3,6,7-naphthalenetetracarboxylic dianhydride, 3,3′,4,4′-dimethyldiphenylsilanetetracarboxylic dianhydride, 3,3′,4,4′-tetraphenylsilanetetracarboxylic dianhydride, 1,2,3,4-furanetetracarboxylic dianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, bis(phthalic acid)phenylphosphine oxide dianhydride, p-phenylene-bis(triphenylphthalic)dianhydride, m-phenylene-bis(triphenylphthalic)dianhydride, bis(triphenylphthalic acid)-4-4′-diphenylether dianhydride, bis(triphenylphthalic acid)-4-4′-diphenylmethane dianhydride, and mixtures thereof.

11. The polyamic acid-based composition of claim 10, wherein said aromatic tetracarboxylic dianhydride component is a mixture of pyromellitic dianhydride and biphenyl tetracarboxylic dianhydride.

12. The polyamic acid-based composition of claim 11, wherein the molar ratio of pyromellitic dianhydride to biphenyl tetracarboxylic dianhydride ranges from 1:1 to 9:1.

13. The polyamic acid-based composition of claim 1, wherein said fluorine-free diamine component is a fluorine-free aromatic diamine selected from the group consisting of 4,4′-bis(4-aminophenoxy)biphenyl, p-phenylenediamine, m-phenylenediamine, 4,4′-diamino-3,3′-dicarboxydiphenylmethane, 1,4-bis(4-aminophenyl)benzene, 4,4′-diaminobiphenyl, 3,3′-dimethyl-4,4′-diaminobiphenyl, 3,3′-dimethoxy-4,4′-diaminobiphenyl, 3,3′-dihydroxy-4,4′-diaminobiphenyl, 3,3′-dichloro-4,4′-diaminobiphenyl, 3,3′-dicarboxy-4,4′-diaminobiphenyl, diaminodiphenylmethane, diaminodiphenyl ether, 2,2-diaminodiphenylpropane, 4,4′-diaminodiphenylsulfone, diaminobenzophenone, 1,3-bis(4-aminophenoxy)benzene, 1,4-bis(4-aminophenoxy)benzene, 4,4′-di(4-aminophenoxy)diphenylsulfone, 2,2-bis-[4-(4-aminophenoxy)phenyl]propane, a compound of formula (II), and mixtures thereof.

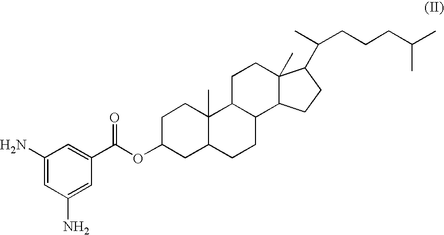

14. The polyamic acid-based composition of claim 13, wherein said fluorine-free diamine component is a mixture of 4,4′-bis(4-aminophenoxy)biphenyl and said compound of formula (II).

15. The polyamic acid-based composition of claim 14, wherein the molar ratio of 4,4′-bis(4-aminophenoxy)biphenyl to said compound of formula (II) ranges from 2:1 to 26:1.

16. The polyamic acid-based composition of claim 1, wherein said aliphatic tetracarboxylic dianhydride component is selected from the group consisting of bicycle(2,2,2)oct-7-ene-2,3,5,6-tetracarboxylic dianhydride, 1,2,3,4-butanetetracarboxylic dianhydride, 3,4-dicarboxy-1,2,3,4-tetrahydro-1-naphthalene succinicanhydride, 2,3,5-tricarboxycyclopentylacetic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 3,5,6-tricarboxynorbornane-2-acetic dianhydride, 2,3,4,5-tetrahydrofurantetracarboxylic dianhydride, and mixtures thereof.

17. A liquid crystal orienting agent comprising a polyamic acid-based composition of claim 1 and a solvent.

18. The liquid crystal orienting agent of claim 17, wherein said solvent is selected from the group consisting of N-methyl-2-pyrrolidinone, ethylene glycol monobutyl ether, dimethylacetamide, dimethylformamide, dimethylsulfoxide, γ-butyrolactone, tetramethylurea, hexamethylphosphor triamide, m-cresol, xylenol, phenol, halogenated phenol chlorobenzene, dichloroethane, tetrachloroethane, cyclohexanone, and mixtures thereof, and wherein said solvent is present in an amount ranging from 80 to 96 wt % based on the total weight of said liquid crystal orienting agent.

19. The liquid crystal orienting agent of claim 18, wherein said solvent is a mixture of N-methyl-2-pyrrolidinone and ethylene glycol monobutyl ether at a weight ratio ranging from 90:10 to 60:40.

20. A liquid crystal orienting film formed by a process comprising: preparing a mixture containing the polyamic acid-based composition of claim 1 and a solvent; coating the mixture onto a substrate so as to form a film on the substrate; and heating the film so as to convert polyamic acid of the polyamic acid-based composition into polyamide.
